(19) United States
(12) Patent Application Publication
(10) Pub. No.: US 2012/0106755 A1
(43) Pub. Date: May 3, 2012

(54) HANDHELD ELECTRONIC DEVICE WITH MICROPHONE ARRAY

(75) Inventor: Ming ZHANG, Nanjing (CN)

(73) Assignee: FORTEMEDIA, INC., Sunnyvale, CA (US)

(21) Appl. No.: 13/346,379

(22) Filed: Jan. 9, 2012

Related U.S. Application Data
(63) Continuation-in-part of application No. 11/567,762, filed on Dec. 7, 2006.
(60) Provisional application No. 60/748,276, filed on Dec. 7, 2005.

(51) Int. Cl. H04R 3/00

(52) U.S. Cl. 381/92

(57) ABSTRACT

A handheld electronic device includes a body and a microphone array. The body includes a side and a recess formed on the side. The microphone array includes a first microphone and a second microphone. Either the first and second microphones are disposed in the recess, or the first microphone is disposed in the recess while the second microphone is disposed outside the recess.

### CROSS REFERENCE TO RELATED APPLICATIONS

This application is a Continuation-In-Part of pending U.S. patent application Ser. No. 11/567,762, filed on Dec. 7, 2006 and entitled “ELECTRONIC DEVICE WITH MICROPHONE ARRAY”, which claims the benefit of U.S. Provisional Application No. 60/748,276, filed on Dec. 7, 2005.

### BACKGROUND OF THE INVENTION

1. Field of the Invention

The invention relates to an electronic device with a microphone array.

2. Description of the Prior Art

Conventionally, electronic devices utilize a single microphone to receive sound. However, the quality of sound received by the single microphone may be poor. Thus, microphone arrays which can effectively cancel noise and suppress echo have become more popular.

A microphone array includes a number of microphones disposed in tandem. A simple example is shown in FIG. 1, wherein the microphone array 10 includes two microphones 11 and 12 placed side by side. Directivity of the microphone array 10 can be achieved by manipulating the signal received by the two microphones 11 and 12. Assuming the two microphones 11 and 12 are omni-directional and having the same characteristics, the direction of the microphone array 10 is designated by vector \vec{d} from one microphone 11 to the other microphone 12.

### BRIEF SUMMARY OF THE INVENTION

The invention provides a handheld electronic device with a microphone array.

The handheld electronic device may comprise a body and a microphone array. The body comprises a side and a recess formed on the side. The microphone array comprises a first microphone and a second microphone, both of which are disposed in the recess.

The first microphone may be located shallower than the second microphone in the recess.

The first and second microphones may be located in such a way that the direction of the microphone array is perpendicular to the side of the body.

The first and second microphones may be located in such a way that the direction of the microphone array is not perpendicular to the side of the body.

The recess may be substantially elliptical, circular, longitudinal, triangular, or other shape.

The handheld electronic device may comprise a body and a microphone array. The body may comprise a side and a recess formed on the side. The microphone array may comprise a first microphone disposed in the recess and a second microphone disposed outside the recess.

The first and second microphones may be located in such a way that the direction of the microphone array is perpendicular to the side of the body.

The first and second microphones may be located in such a way that the direction of the microphone array is not perpendicular to the side of the body.

The recess may be substantially elliptical, circular, longitudinal, triangular, or other shape.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic diagram of a conventional microphone array;

FIG. 2A is a schematic diagram of a handheld electronic device in accordance with an embodiment of the invention;

FIG. 2B is a partially sectional view of the handheld electronic device of FIG. 2A along line II-II;

FIG. 3A is a schematic diagram of a handheld electronic device in accordance with another embodiment of the invention;

FIG. 3B is a partially sectional view of the handheld electronic device of FIG. 3A along line III-III;

FIG. 4A is a schematic diagram of a handheld electronic device in accordance with another embodiment of the invention;

FIG. 4B is a partially sectional view of the handheld electronic device of FIG. 4A along line IV-IV;

FIG. 5A is a schematic diagram of a handheld electronic device in accordance with another embodiment of the invention;

FIG. 5B is a partially sectional view of the handheld electronic device of FIG. 5A along line V-V;

FIG. 6A is a schematic diagram of a handheld electronic device in accordance with another embodiment of the invention;

FIG. 6B is a partially sectional view of the handheld electronic device of FIG. 6A; and

FIG. 7 is a schematic diagram of a handheld electronic device in accordance with another embodiment of the invention.

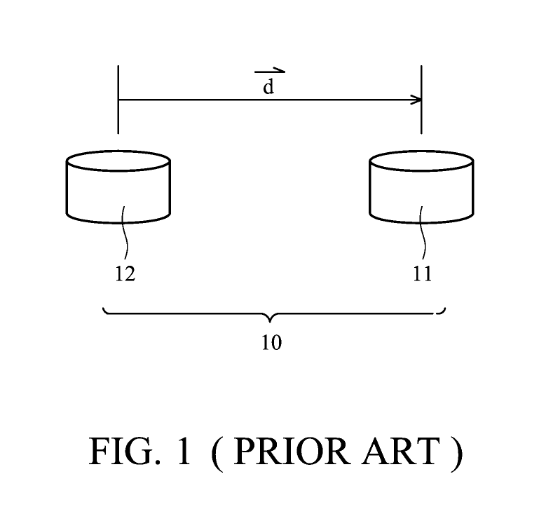

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

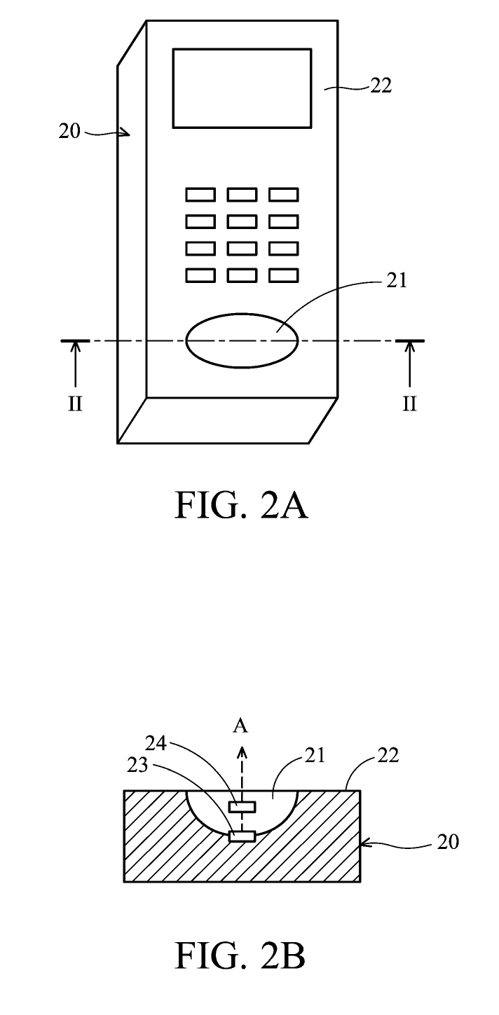

Referring to FIG. 2A, a handheld electronic device of an embodiment of the invention comprises a body 20. A recess 21 is formed at the front 22 of the body 20 and is substantially elliptical. The handheld electronic device may be a mobile phone, smart phone or PDA, and a diameter 21 of the recess 21 may be less than 2 cm.

Referring to FIG. 2B, a first microphone 23 and a second microphone 24 are disposed in the recess 21 to constitute a microphone array. The first microphone 23 is located at the bottom of the recess 21. The second microphone 24 is located over the first microphone 23. Thus, the direction A of the microphone array is perpendicular to the front 22 of the body 20. In operation, the recess 21 collects and reflects sound waves to the first and second microphones 23 and 24.

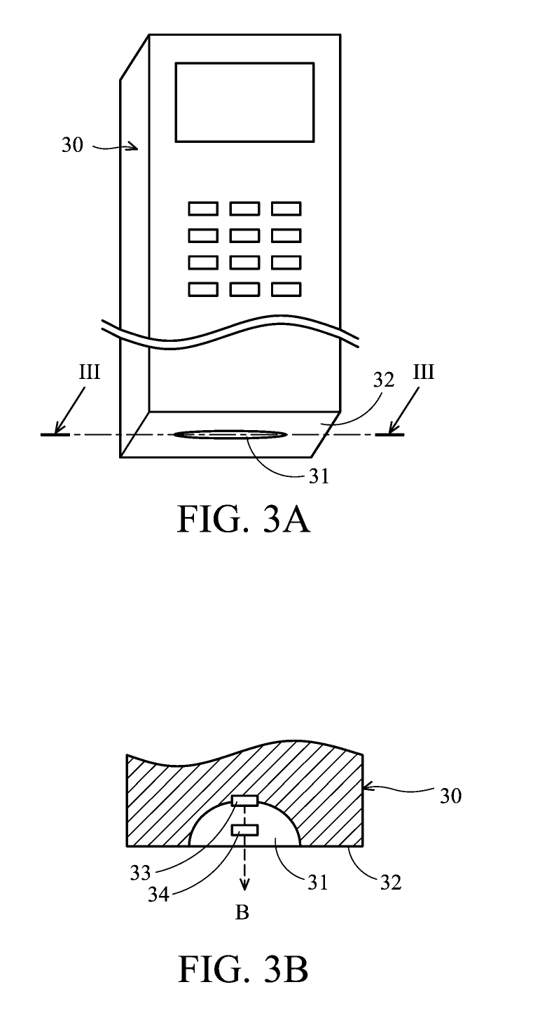

Referring to FIG. 3A, a handheld electronic device of another embodiment of the invention comprises a body 30. A recess 31 is formed at the bottom 32 of the body 30 and is substantially longitudinal. In this embodiment, the handheld electronic device may be a mobile phone, smart phone or PDA, and a diameter 21 of the recess 21 may be less than 2 cm.

Referring to FIG. 3B, a first microphone 33 and a second microphone 34 are disposed in the recess 31 to constitute a microphone array. The first microphone 33 is located at the deepest location of the recess 31. The second microphone 34 is located under the first microphone 33. Thus, the direction B of the microphone array is perpendicular to the bottom 32 of the body 30. In operation, the recess 31 collects and reflects sound waves to the first and second microphones 33 and 34.

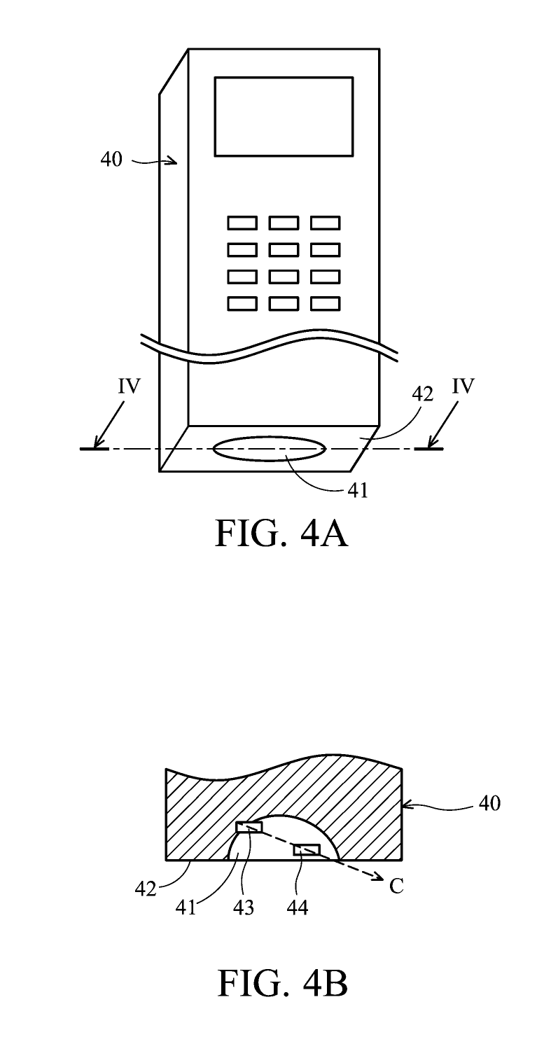

Referring to FIG. 4A, a handheld electronic device of another embodiment of the invention comprises a body 40. A recess 41 is formed at the bottom 42 of the body 40 and is substantially elliptical. In this embodiment, the handheld electronic device may be a mobile phone, smart phone or PDA, and a diameter 21 of the recess 21 may be less than 2 cm.

Referring to FIG. 4B, a first microphone 43 and a second microphone 44 are disposed in the recess 41 to constitute a microphone array. The second microphone 44 is located below the first microphone 43. The direction C of the microphone array is not perpendicular to the bottom 42 of the body 40 because the second microphone 44 is not exactly under the first microphone 43. In operation, the recess 41 collects and reflects sound waves to the first and second microphones 43 and 44.

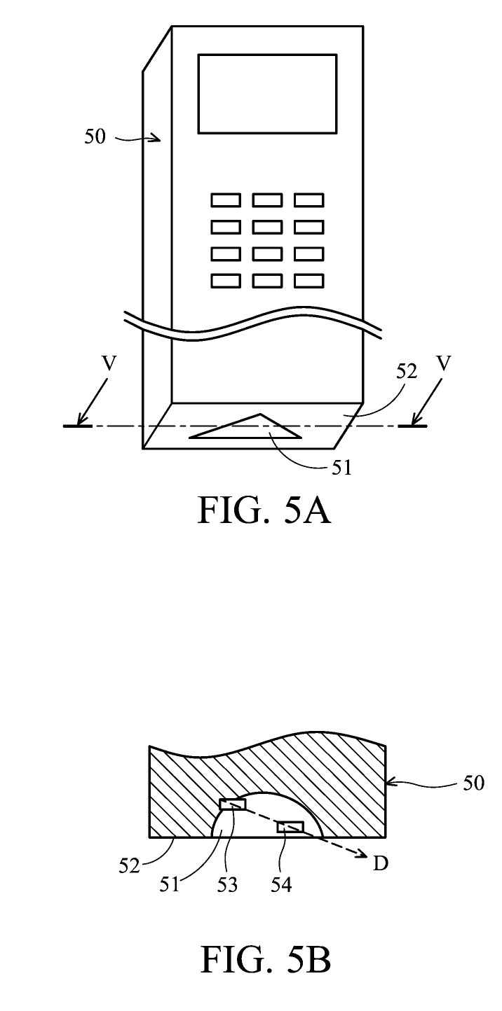

Referring to FIG. 5A, a handheld electronic device of another embodiment of the invention comprises a body 50. A recess 51 is formed at the bottom 52 of the body 50 and is substantially triangular. In this embodiment, the handheld electronic device may be a mobile phone, smart phone or PDA, and a diameter 21 of the recess 21 may be less than 2 cm.

Referring to FIG. 5B, a first microphone 53 and a second microphone 54 are disposed in the recess 51 to constitute a microphone array. The second microphone 54 is located below the first microphone 53. The direction D of the microphone array is not perpendicular to the bottom 52 of the body 50. In operation, the recess 51 collects and reflects sound waves to the first and second microphones 53 and 54.

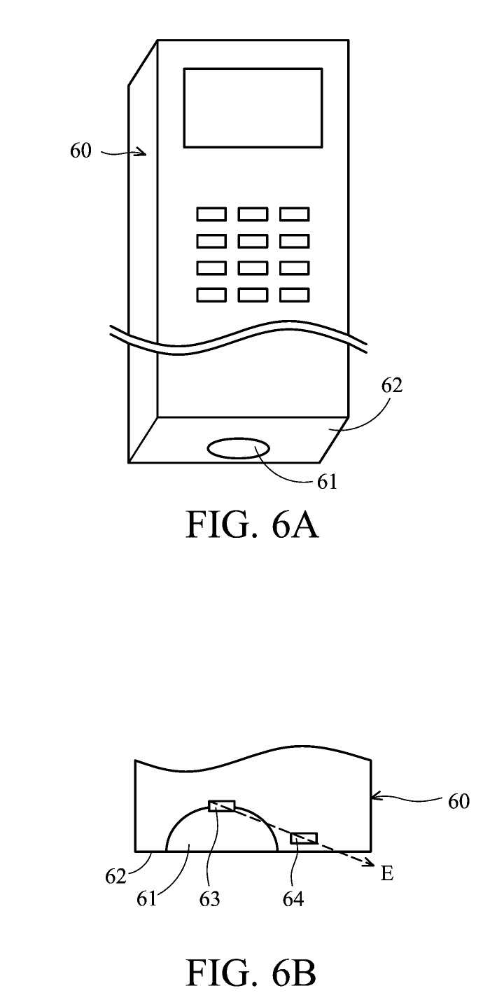

Referring to FIG. 6A, a handheld electronic device of another embodiment of the invention comprises a body 60. A recess 61 is formed at the bottom 62 of the body 60 and is substantially circular. In this embodiment, the handheld electronic device may be a mobile phone, smart phone or PDA, and a diameter 21 of the recess 21 may be less than 2 cm.

Referring to FIG. 6B, a first microphone 63 in the recess 61 and a second microphone 64 outside the recess 61 constitute a microphone array. The second microphone 64 is located below the first microphone 63. Thus, the direction E of the microphone array is not perpendicular to the bottom 62 of the body 60. In operation, the recess 61 collects and reflects sound waves to the first and second microphones 63 and 64.

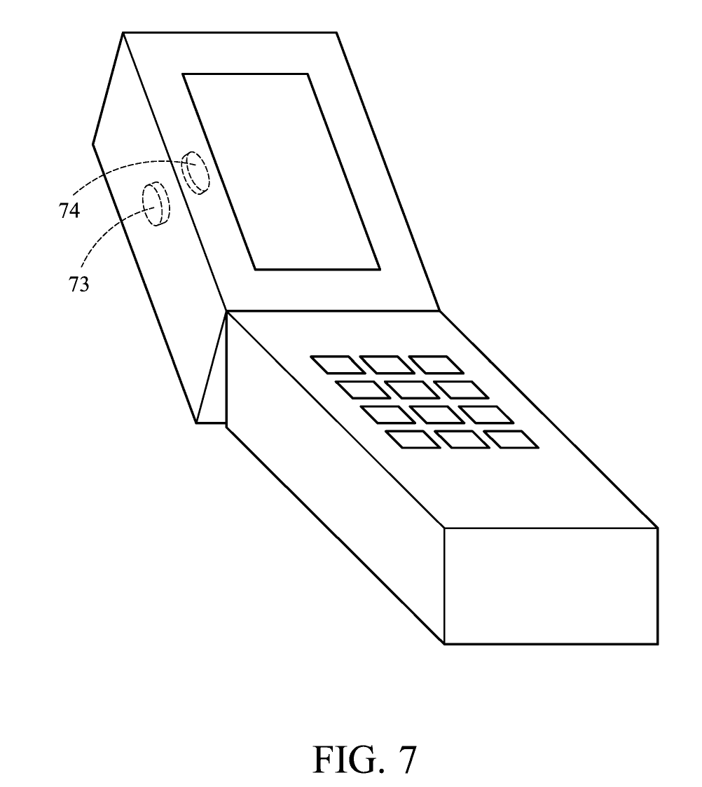

It is understood that first microphone and second microphones are not necessarily disposed on the same side of the body of the handheld electronic device. As shown in FIG. 7, a first microphone 73 is disposed on the side while a second microphone 74 is disposed at the front.

It is understood that the microphone array can include uni-directional microphones, omni-directional microphones, or combinations thereof. In some embodiments, all of the microphones in the microphone array can be omni-directional microphones. Since the directivity of the microphone array is achieved by manipulating the signal received by the first and second microphones, the dimensions of the recess can be less than 2 cm to facilitate miniaturization of the microphone array.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A handheld electronic device, comprising:
a body, comprising a side and a recess formed on the side; and
a microphone array, comprising a first microphone and a second microphone disposed in the recess, wherein the first and second microphones are both omni-directional microphones arranged to define directivity of the microphone array, and the recess has a diameter less than 2 cm and is configured to collect and reflect sound waves to the first and second microphones.

2. The handheld electronic device as claimed in claim 1, wherein the first microphone is located shallower than the second microphone in the recess.

3. The handheld electronic device as claimed in claim 1, wherein the first and second microphones are located in such a way that the direction of the microphone array is perpendicular to the side of the body.

4. The handheld electronic device as claimed in claim 1, wherein the first and second microphones are located in such a way that the direction of the microphone array is not perpendicular to the side of the body.

5. The handheld electronic device as claimed in claim 1, wherein the recess is substantially elliptical.

6. The handheld electronic device as claimed in claim 1, wherein the recess is substantially circular.

7. The handheld electronic device as claimed in claim 1, wherein the recess is substantially longitudinal.

8. The handheld electronic device as claimed in claim 1, wherein the recess is substantially triangular.

9. A handheld electronic device, comprising:
a body comprising a side and a recess formed on the side; and
a microphone array comprising a first microphone disposed in the recess and a second microphone disposed outside the recess, wherein the first and second microphones are both omni-directional microphones arranged to define directivity of the microphone array, and the recess has a diameter less than 2 cm and is configured to collect and reflect sound waves to the first and second microphones.

10. The handheld electronic device as claimed in claim 9, wherein the first and second microphones are located in such a way that the direction of the microphone array is perpendicular to the side of the body.

11. The handheld electronic device as claimed in claim 9, wherein the first and second microphones are located in such a way that the direction of the microphone array is not perpendicular to the side of the body.

12. The handheld electronic device as claimed in claim 9, wherein the recess is substantially elliptical.

13. The handheld electronic device as claimed in claim 9, wherein the recess is substantially circular.

14. The handheld electronic device as claimed in claim 9, wherein the recess is substantially longitudinal.

15. The handheld electronic device as claimed in claim 9, wherein the recess is substantially triangular.
